(19) United States
(12) Patent Application Publication
(10) Pub. No.: US 2026/0159658 A1
(43) Pub. Date: Jun. 11, 2026

(54) METHOD FOR PRODUCING CARBON-COATED MEMBER, COATING COMPOSITION, AND METHOD FOR PRODUCING CARBONACEOUS MATERIAL

(71) Applicant: Resonac Corporation, Tokyo (JP)

(72) Inventors: Motohiro ARIFUKU, Tokyo (JP); Toru YOSHIKAWA, Tokyo (JP); Shigeyuki NISHIKI, Tokyo (JP); Ryutaro NAGATA, Tokyo (JP); Katsuyuki MASUDA, Tokyo (JP)

(21) Appl. No.: 18/707,732

(22) PCT Filed: Oct. 7, 2022
(86) PCT No.: PCT/JP2022/037697

§ 371 Date: May 6, 2024

(30) Foreign Application Priority Data
Nov. 9, 2021 (JP) 2021-182663

(51) Int. Cl. C08J 7/06; B05D 7/02

(52) U.S. Cl. CPC C08J 7/06; B05D 7/02; B05D 2201/02

(57) ABSTRACT

A method for producing a carbon-coated member includes a step of heating a coating composition including a carboxylic acid anhydride and sulfuric acid in a state in which a portion or the entirety of a surface of a member to be coated is in contact with the coating composition, and a concentration of the sulfuric acid in the coating composition before heating is 0.4% by mass or more based on the sum of masses of the carboxylic acid anhydride and the sulfuric acid.

### TECHNICAL FIELD

The present disclosure relates to a method for producing a carbon-coated member, a coating composition, and a method for producing a carbonaceous material.

### BACKGROUND ART

Carbonaceous materials such as diamond, graphite, and amorphous carbon (glassy carbon) are utilized as corrosion-resistant coatings due to their high stability against acids and alkalis.

Regarding methods of coating (carbon coating) with carbonaceous materials, for example, a dry method such as CVD (chemical-vapor-deposition) as disclosed in Patent Literature 1 mentioned below, and an electroplating method using a carbon molten salt as disclosed in Patent Literature 2 mentioned below are known.

### CITATION LIST

### Patent Literature

Patent Literature 1: International Publication WO 2011/025045
Patent Literature 2: Japanese Unexamined Patent Publication No. 2009-120860

### SUMMARY OF INVENTION

### Technical Problem

The above-described methods require complicated apparatuses and also have problems in view of production cost, energy consumption, and limitations on the shape and material of the member to be coated, such as that a high temperature of 300° C. or higher is required to provide sufficient carbon coating to a member to be coated, and that it is difficult to coat particles and insulators.

Thus, it is an object of the present disclosure to provide a method and a coating composition, which make it possible to obtain a carbon-coated member simply and efficiently with a high degree of freedom in the shape and material of the member, and a method for producing a carbonaceous material, in which a carbonaceous material can be produced simply and efficiently.

### Solution to Problem

In order to solve the above-described problems, an aspect of the present disclosure provides a method for producing a carbon-coated member, the method including a step of heating a coating composition including a carboxylic acid anhydride and sulfuric acid in a state in which a portion or the entirety of a surface of a member to be coated is in contact with the coating composition, in which a concentration of the sulfuric acid in the coating composition before heating is 0.4% by mass or more based on a sum of masses of the carboxylic acid anhydride and the sulfuric acid.

According to the above-described production method, members to be coated of various shapes and materials can be carbon-coated by a simple step of heating using a coating composition, even under low-temperature conditions.

A content of the carboxylic acid anhydride in the coating composition before heating may be 40% by mass or more based on a total mass of the coating composition.

A heating temperature in the above-described step may be 100° C. to 300° C.

The member to be coated may be in a particulate form. In this case, carbon-coated particles can be produced.

The member to be coated may be an insulator.

Another aspect of the present disclosure provides a coating composition used for carbon-coating a surface of a member to be coated, the coating composition including a carboxylic acid anhydride and sulfuric acid, in which a concentration of the sulfuric acid is 0.5% by mass or more based on a sum of masses of the carboxylic acid anhydride and the sulfuric acid.

According to the above-described coating composition, members to be coated of various shapes and materials can be carbon-coated, even under low-temperature conditions, by a simple step of bringing the coating composition into contact with a member to be coated and then performing heating.

A content of the carboxylic acid anhydride in the coating composition may be 40% by mass or more based on a total mass of the coating composition.

Another aspect of the present disclosure provides a method for producing a carbonaceous material, the method including a step of heating a carboxylic acid anhydride in the presence of a sulfuric acid within a system, in which an amount of the sulfuric acid present in the system before heating is 0.4% by mass or more based on a sum of masses of the carboxylic acid anhydride and the sulfuric acid.

According to the above-described production method, a carbonaceous material can be produced even under low-temperature conditions, and the carbonaceous material can be easily collected from the system with sufficient yield.

The heating temperature in the above-described step may be 100° C. to 300° C.

### Advantageous Effects of Invention

According to the present disclosure, a method and a coating composition, which make it possible to obtain a carbon-coated member simply and efficiently with a high degree of freedom in the shape and material of the member, and a method for producing a carbonaceous material, in which a carbonaceous material can be produced simply and efficiently, can be provided.

### DESCRIPTION OF EMBODIMENTS

In the present specification, a numerical value range expressed using the term “to” represents a range including the numerical values described before and after the term “to” as the minimum value and the maximum value, respectively. With regard to a numerical value range described in stepwise in the present specification, the upper limit value or lower limit value of a numerical value range of a certain stage may be replaced with the upper limit value or lower limit value of a numerical value range of another stage. Furthermore, with regard to a numerical value range described in the present specification, the upper limit value or lower limit value of the numerical value range may be replaced with a value indicated in the Examples. Furthermore, upper limit values and lower limit values that are described individually can be arbitrarily combined. Furthermore, “A or B” may include either A or B or may include both. In addition, unless particularly stated otherwise, the materials mentioned below as examples may be used singly or may be used in combination of two or more kinds thereof. Regarding the content of each component in the composition, in a case where there are a plurality of substances corresponding to each component In the composition, unless particularly stated otherwise, the content means the total amount of the plurality of substances present in the composition.

### <Method for Producing Carbon-Coated Member>

A method for producing a carbon-coated member of the present embodiment includes a first step of heating a coating composition including a carboxylic acid anhydride and sulfuric acid in a state in which a portion or the entirety of the surface of a member to be coated is in contact with the coating composition. In the first step, a carbon coating is formed on the surface of a member to be coated, and thereby a carbon-coated member can be obtained.

### (Coating Composition)

A coating composition of the present embodiment includes a carboxylic acid anhydride and sulfuric acid.

Examples of the carboxylic acid anhydride include carboxylic acid anhydrides derived from aliphatic carboxylic acids or aromatic carboxylic acids. The carboxylic acid anhydrides can be used singly or in combination of two or more kinds thereof.

The carboxylic acid constituting the carboxylic acid anhydride may be a monocarboxylic acid or a polycarboxylic acid.

Examples of the carboxylic acid include an aliphatic carboxylic acid having 2 to 12 carbon atoms, and an aromatic carboxylic acid. Specific examples of the carboxylic acid include aliphatic carboxylic acids such as acetic acid, propionic acid, butyric acid, valeric acid, caproic acid, heptanoic acid, caprylic acid, pelargonic acid, maleic acid, and succinic acid; and aromatic carboxylic acids such as benzoic acid, phthalic acid, and naphthalic acid.

From the viewpoints of price and easy availability, a carboxylic acid anhydride derived from an aliphatic carboxylic acid may be used, or from the viewpoint of reactivity, acetic anhydride may be used. Furthermore, since acetic anhydride is a liquid at room temperature (25° C.), separation and washing of the obtained carbon-coated member are facilitated.

The coating composition may include a solvent. Examples of the solvent include an ether, an alcohol, a ketone, and an aldehyde that are not carbonized by sulfuric acid. The solvents can be used singly or in combination of two or more kinds thereof.

Carboxylic acid anhydrides that are liquid at room temperature, such as acetic anhydride and propionic anhydride, can also be allowed to function as a solvent in the coating composition. Since carboxylic acid anhydrides have strong hydrogen bonding properties and crystallinity, many of the compounds are solid at room temperature (for example, succinic anhydride and maleic anhydride); however, in that case, solutions dissolved in the above-described solvents or the carboxylic acid anhydrides that are liquid at room temperature may be used.

A carboxylic acid anhydride that is solid at room temperature is crystallized when returned to room temperature after the reaction treatment of the first step, and handling tends to become difficult; however, when the above-described solutions are used, separation and washing of the carbon-coated member are facilitated.

From the viewpoint that separation and washing of the carbon-coated member are facilitated, the coating composition may be liquid at room temperature (25° C.), and the viscosity at 25° C. may be 10000 mPas or less. The viscosity as used here is a value measured with an E-ta viscometer.

The content of the carboxylic acid anhydride in the coating composition before heating may be 40% by mass or more, 50% by mass or more, 60% by mass or more, or 70% by mass or more, based on the total mass of the coating composition.

The concentration of sulfuric acid in the coating composition before heating can be set to 0.4% by mass or more based on the sum of masses of the carboxylic acid anhydride and the sulfuric acid. As a result, members to be coated of various shapes and materials can be carbon-coated by the first step, even under low-temperature conditions.

According to the present embodiment, the concentration of sulfuric acid in the coating composition can be adjusted based on the purity and blending amount of concentration of sulfuric acid blended in the coating composition. The purity of concentrated sulfuric acid can be measured by titration with a base.

From the viewpoints of lowering the temperature and shortening the time of the carbon coating treatment, the concentration of sulfuric acid in the coating composition before heating can be set to 0.4% by mass or more based on the sum of masses of the carboxylic acid anhydride and the sulfuric acid, and the concentration may also be 0.5% by mass or more, 0.9% by mass or more, 2% by mass or more, 4% by mass or more, 5% by mass or more, or 9% by mass or more.

From the viewpoint of facilitating separation between the carbon-coated member and the coating composition after the treatment, the concentration of sulfuric acid in the coating composition before heating may be 30% by mass or less or may be 10% by mass or less, based on the sum of masses of the carboxylic acid anhydride and the sulfuric acid.

From the viewpoint of yield, the content of water in the coating composition before heating may be 5% by mass or less, 1% by mass or less, or 0.1% by mass or less, based on the total mass of the coating composition (provided that a metal catalyst is excluded).

The coating composition may also contain additives such as a silane coupling agent and a sedimentation inhibitor, to the extent that the carbon coating treatment is not impaired.

### (Member to be Coated)

The member to be coated may include various materials such as a metal, an insulator, an organic substance, an inorganic substance, a hydrophilic substance, and a hydrophobic substance. For example, the member to be coated may contain a metal requiring an anti-rust treatment, such as iron, aluminum, stainless steel, or titanium.

Furthermore, the member to be coated may contain a fluorine-based resin such as polytetrafluoroethylene, which is generally difficult to be coated. In addition, the member to be coated may be composed of materials such as glass and ceramics, which are difficult to be coated by the above-mentioned methods described in Patent Literatures 1 and 2.

Furthermore, the member to be coated may have a particulate shape, a plate-like shape, a block-like shape, or the like, or may have an irregular shape. When the member to be coated is in a particulate form, carbon-coated particles can be produced.

When a member to be coated is in a particulate form, the primary particle size (or average primary particle size) may be 0.05 μm or more, or may be 1 μm to 10000 μm. Examples of a particulate member to be coated include particles of oxides such as silica and alumina; particles of metals such as copper, gold, iron, stainless steel, and titanium; and particles of organic substances such as polytetrafluoroethylene, a styrene-based resin, and an acrylic resin.

The member to be coated may be, for example, a negative electrode material of a lithium battery.

### (First Step)

The contact between a member to be coated and a coating composition can be carried out by a method of immersing the member to be coated in the coating composition, or the like.

The heating temperature of the coating composition may be 100° C. to 300° C., may be 150° C. to 250° C., or may be 180° C. to 220° C. From the viewpoint of reducing the influence of heat on the member to be coated, the heating temperature may be 180° C. to 200° C.

Regarding the heating of the coating composition, the coating composition may be heated directly, or the coating composition in contact with the member to be coated may be heated by heating this member.

The heating may be performed under normal pressure (atmospheric pressure), or may be performed under pressure. When the heating is performed under pressure, the temperature can be raised to a temperature higher than or equal to the boiling points at normal pressure of the components included in the coating composition, and therefore, the heating time can be shortened as compared with the case of heating at normal pressure.

When applying pressure, for example, a pressure-resistant container such as an autoclave can be used. When a pressure-resistant container is used, it is easy to heat the coating composition to a temperature higher than or equal to the boiling point at normal pressure of the carboxylic acid anhydride (for example, 140° C. for acetic anhydride).

When applying pressure, the pressure may be 200 kPa to 5.0 MPa, or may be 500 kPa to 2.0 MPa.

The heating time may be 1 minute to 24 hours, may be 30 minutes to 15 hours, or may be 1 hour to 5 hours.

### (Second Step)

According to the present embodiment, a second step of washing the carbon-coated member (member to be coated on which a carbon coating has been applied) can be further provided after the first step.

In the second step, for example, the coating composition after the treatment can be removed by washing the carbon-coated member using one or more selected from water and organic solvents. Examples of the organic solvent include an alcohol such as ethanol, and a hydrocarbon compound such as toluene.

According to the above-mentioned method for producing a carbon-coated member, a member in which the carbon coating is a carbon film including graphene can be obtained.

### <Method for Producing Carbonaceous Material>

A method for producing a carbonaceous material of the present embodiment includes step A of heating a carboxylic acid anhydride in the presence of a sulfuric acid within a system.

The reaction system in the above-described method may be a solution or may be a liquid dispersion in which a solid carboxylic acid anhydride is dispersed. The solution may be similar to the above-mentioned coating composition. Furthermore, when heating is performed under pressure, a closed system such as an autoclave can be adopted.

Regarding the carboxylic acid anhydride, those described in connection with the above-mentioned coating composition can be used.

The amount of sulfuric acid present within the system before heating can be set to 0.4% by mass or more based on the sum of masses of the carboxylic acid anhydride and the sulfuric acid, and the amount may be 0.5% by mass or more, 0.9% by mass or more, 2% by mass or more, 4% by mass or more, 5% by mass or more, or 9% by mass or more, while the amount may also be 30% by mass or less, may be 10% by mass or less, or may be 2% to 10% by mass, or 5% to 30% by mass.

When the system is a solution, the amount of sulfuric acid present in the solution can be set to be similar to the content of sulfuric acid in the above-mentioned coating composition.

When the system is a solution, the heating temperature, the heating time, and the pressure when pressure is applied can be set similarly to the first step in the above-mentioned method for producing a carbon-coated member.

In the step A, a carbonaceous material is produced using a carboxylic acid anhydride as a carbon source. Examples of the carbonaceous material include graphene, graphite, amorphous carbon, and diamond.

The method for producing a carbonaceous material of the present embodiment may further include, after the step A, step B of separating the carbonaceous material from the system.

Step B may include, for example, performing washing with one or more selected from water and organic solvents, followed by separation by centrifugation or filtering through a filter with a predetermined pore size. Regarding the organic solvents, those mentioned for the description of the second step can be used.

The carbonaceous material obtained by the production method of the present embodiment can be utilized as raw materials of an electromagnetic wave-absorbing material, an antibacterial agent, a luminescent material, a battery electrode material, a thermally conductive material, an electrically conductive material, and the like.

The present disclosure can provide inventions described in the following [1] to [9].

[1] A method for producing a carbon-coated member, the method including a step of heating a coating composition including a carboxylic acid anhydride and sulfuric acid in a state in which a portion or the entirety of a surface of a member to be coated is in contact with the coating composition, in which a concentration of the sulfuric acid in the coating composition before heating is 0.4% by mass or more based on a sum of masses of the carboxylic acid anhydride and the sulfuric acid. [2] The method for producing a carbon-coated member according to the above-described [1], in which a content of the carboxylic acid anhydride in the coating composition before heating is 40% by mass or more based on a total mass of the coating composition.

[3] The method for producing a carbon-coated member according to the above-described [1] or [2], in which a heating temperature in the step is 100° C. to 300° C.

[4] The method for producing a carbon-coated member according to any one of the above-described [1] to [3], in which the member to be coated is in a particulate form.

[5] The method for producing a carbon-coated member according to any one of [1] to [4], in which the member to be coated is an insulator.

[6] A coating composition used for carbon-coating a surface of a member to be coated, the coating composition including a carboxylic acid anhydride and sulfuric acid, in which a concentration of sulfuric acid is 0.5% by mass or more based on a sum of masses of the carboxylic acid anhydride and the sulfuric acid.

[7] The coating composition according to the above-described [6], in which a content of the carboxylic acid anhydride is 40% by mass or more based on a total mass of the coating composition.

[8] A method for producing a carbonaceous material, the method including a step of heating a carboxylic acid anhydride in the presence of a sulfuric acid in a system, in which an amount of sulfuric acid present in the system before heating is 0.4% by mass or more based on a sum of masses of the carboxylic acid anhydride and the sulfuric acid.

[9] The method for producing a carbonaceous material according to the above-described [8], in which a heating temperature in the step is 100° C. to 300° C.

### EXAMPLES

Hereinafter, the present disclosure will be described more specifically by way of Examples; however, the present disclosure is not limited to the Examples.

### Example 1

19.9 g of acetic anhydride, 0.1 g of concentrated sulfuric acid, and a stirrer (first member to be coated) formed of a magnet coated with TEFLON (registered trademark) were put into a TEFLON (registered trademark) container having a capacity of 100 ml. Next, this TEFLON (registered trademark) container was placed in a stainless steel pressure-resistant vessel, and the pressure-resistant vessel was tightly sealed.

Within the sealed pressure-resistant vessel, the solution inside the TEFLON (registered trademark) container was heated with a heater such that the temperature of the solution reached 190° C., while being stirred at a speed of rotation of 300 rpm using the magnetic stirrer. After the temperature reached 190° C., a heating and pressurization treatment was carried out for 5 hours under the conditions of 190° C. and 0.5 MPa while stirring was continued.

Thereafter, heating and stirring were stopped, and the system was naturally cooled to normal temperature (25° C.). The highest temperature reached during the treatment was 191° C. After cooling, the member to be coated, the solution, and a solid component in the TEFLON (registered trademark) container were taken out into a beaker.

Regarding the concentrated sulfuric acid, “Sulfuric Acid High-Purity Special Grade (concentration 95%)” (manufactured by FUJIFILM Wako Pure Chemical Corporation) was used.

### Examples 2 to 5

The treatment was carried out in the same manner as in Example 1, except that the blending amounts of acetic anhydride and concentrated sulfuric acid were changed to the amounts shown in Table 1.

### Example 6

The treatment was carried out in the same manner as in Example 2, except that 0.2 g of a glass plate (size: 2 mm×5 mm×0.1 mm) was further put into the TEFLON (registered trademark) container as a second member to be coated.

### Example 7

The treatment was carried out in the same manner as in Example 2, except that 1 g of silica particles (average primary particle size: 1.5 μm) were further put into the TEFLON (registered trademark) container as a second member to be coated.

### Examples 8 to 12

The treatment was carried out in the same manner as in Example 2, except that each of the carboxylic acid anhydrides shown in Table 2 or Table 3 (succinic anhydride, maleic anhydride, phthalic anhydride, propionic anhydride, or propionic anhydride and succinic anhydride) was blended instead of acetic anhydride. Meanwhile, in Example 12, 19 g of propionic anhydride and 1 g of succinic anhydride were blended.

### Comparative Example 1

The treatment was carried out in the same manner as in Example 1, except that concentrated sulfuric acid was not blended, and the blending amount of acetic anhydride was changed to 20 g.

### Comparative Example 2

The treatment was carried out in the same manner as in Comparative Example 1, except that 0.2 g of a glass plate (size: 2 mm×5 mm×0.1 mm) was further put into the TEFLON (registered trademark) container as a second member to be coated.

### Comparative Example 3

The treatment was carried out in the same manner as in Comparative Example 1, except that 1 g of silica particles (average primary particle size: 1.5 μm) were further put into the TEFLON (registered trademark) container as a second member to be coated.

### Comparative Example 4

The treatment was carried out in the same manner as in Example 1, except that the blending amounts of acetic anhydride and concentrated sulfuric acid were changed to the amounts shown in Table 5.

### Comparative Example 5

The treatment was carried out in the same manner as in Comparative Example 4, except that 0.2 g of a glass plate (size: 2 mm×5 mm×0, 1 mm) was further put into the TEFLON (registered trademark) container as a second member to be coated.

### Comparative Example 6

The treatment was carried out in the same manner as in Comparative Example 4, except that 1 g of silica particles (average primary particle size: 1.5 μm) were further put into the TEFLON (registered trademark) container as a second member to be coated.

### Comparative Example 7

The treatment was carried out in the same manner as in Example 2, except that the compound shown in Table 5 (ethanol) was blended as a carbon source compound other than the carboxylic acid anhydride, instead of acetic anhydride.

### <Evaluation>

In Examples and Comparative Examples, after cooling, the member to be coated and the solution (including a solid component) inside the TEFLON (registered trademark) container were taken out into a beaker. For these, verification of carbon coating, measurement of the amount of carbon, measurement of the supernatant yield, and verification of graphene production were carried out by the following methods.

### [Verification of Carbon Coating]

The surface of the member to be coated was checked by visual inspection to see whether a black coating had been newly formed, and the carbon coating was evaluated according to the following determination criteria.
A: The entire surface of the member is covered with a black coating.
B: The member is covered with a black coating; however, the base color (color of the member) is partially exposed.
C: A black coating is not recognized.

### [Measurement of Amount of Carbon]

When a carbon coating was confirmed on the second member to be coated, the ratio (%) of the amount of carbon on the member surface was measured using an energy dispersive X-ray spectrometer EDX (manufactured by Hitachi High-Tech Corporation).

### [Measurement of Supernatant Yield]

1 L of water was introduced into the solution (reaction liquid from which the member to be coated (excluding a powder) had been removed), and the mixture was treated with a centrifuge at a speed of rotation of 10000 rpm for 30 minutes to separate a supernatant (supernatant liquid A). A step of introducing 1 L of water into the settled solid component, stirring the mixture, and performing centrifugation again was carried out two times. For the solid component obtained in this manner, the weight after drying at 100° C. in an oven for 6 hours was measured. The weight ratio with respect to the carboxylic acid anhydride before the treatment (before heating) was designated as supernatant yield (%).

### [Verification of Graphene Production]

The supernatant liquid A was diluted 400 times with acetic anhydride to obtain a diluted solution. This diluted solution was irradiated with ultraviolet light at 365 nm using a “Handy UV Lump LUV-4” manufactured by AS ONE CORPORATION, and the presence or absence of light emission and the color of light were observed by visual inspection. In a case where emission of light from blue to yellow was observed, it was assumed that graphene had been produced, and the case was indicated as “Present”, whereas in a case where emission of light from blue to yellow was not observed, it was assumed that graphene had not been produced, and the case was indicated as “Absent”.

TABLE 1

| | | Example 1 | Example 2 | Example 3 | Example 4 | Example 5 |
|---|---|---|---|---|---|---|
| Carboxylic acid | Type | Acetic | Acetic | Acetic | Acetic | Acetic |
| anhydride | | anhydride | anhydride | anhydride | anhydride | anhydride |
| | Blending | 19.9 | 19.8 | 19.0 | 17.0 | 16.0 |
| | amount (g) | | | | | |
| Concentrated | Blending | 0.1 | 0.2 | 1.0 | 3.0 | 4.0 |
| sulfuric acid | amount (g) | | | | | |

| | | | | | |
|---|---|---|---|---|---|
| First member to be coated (material) | TEFLON | TEFLON | TEFLON | TEFLON | TEFLON |
| Heating temperature (° C.) | 190 | 190 | 190 | 190 | 190 |
| Heating time (h) | 5 | 5 | 5 | 5 | 5 |
| Carbon coating on first member to be | B | A | A | A | A |
| coated | | | | | |
| Supernatant yield of carbonaceous | 2 | 5 | 22 | 31 | 14 |
| material | | | | | |
| Graphene production | Present | Present | Present | Present | Present |

“TEFLON” described in the table is registered trademark.

TABLE 2

| | | Example 6 | Example 7 | Example 8 | Example 9 | Example 10 |
|---|---|---|---|---|---|---|
| Carboxylic acid | Type | Acetic | Acetic | Succinic | Maleic | Phthalic |
| anhydride | | anhydride | anhydride | anhydride | anhydride | anhydride |
| | Blending | 19.8 | 19.8 | 19.8 | 19.8 | 19.8 |
| | amount (g) | | | | | |
| Concentrated sulfuric | Blending | 0.2 | 0.2 | 0.2 | 0.2 | 0.2 |
| acid | amount (g) | | | | | |

| | | | | | |
|---|---|---|---|---|---|
| First member to be coated (material) | TEFLON | TEFLON | TEFLON | TEFLON | TEFLON |
| Second member to be coated | Glass plate | Silica | — | — | — |
| | | particles | | | |
| Heating temperature (° C.) | 190 | 190 | 190 | 190 | 190 |
| Heating time (b) | 5 | 5 | 5 | 5 | 5 |
| Carbon coating on first member to be | A | A | A | A | A |
| coated | | | | | |
| Amount of carbon in second member to | 42.5 | 50.3 | — | — | — |
| be coated (%) | | | | | |
| Supernatant yield of carbonaceous | 1 | — | 0.5 | 0.4 | 0.6 |
| material | | | | | |
| Graphene production | Present | Present | Present | Present | Present |

“TEFLON” described in the table is registered trademark.

TABLE 3

| | | Example 11 | Example 12 |
|---|---|---|---|
| Carboxylic acid | Type | Propionic | Propionic |
| anhydride | | anhydride | anhydride/ |
| | | | succinic |
| | | | anhydride |
| | Blending amount (g) | 19.8 | 19/1 |
| Concentrated | Blending amount (g) | 0.2 | 0.2 |
| sulfuric acid | | | |

| | | |
|---|---|---|
| First member to be coated | TEFLON | TEFLON |
| (material) | | |
| Second member to be coated | — | — |
| Heating temperature (° C.) | 190 | 190 |
| Heating time (h) | 5 | 5 |
| Carbon coating on first member to be coated | A | A |
| Amount of carbon in second member to be | — | — |
| coated (EDX) | | |
| Supernatant yield of carbonaceous material | 0.6 | 0.7 |
| Graphene production | Present | Present |

“TEFLON” described in the table is registered trademark.

TABLE 4

| | | Comparative | Comparative | Comparative |
|---|---|---|---|---|
| | | Example 1 | Example 2 | Example 3 |
| Carboxylic | Type | Acetic | Acetic | Acetic |
| acid | | anhydride | anhydride | anhydride |
| anhydride | Blending | 20.0 | 20.0 | 20.0 |
| | amount (g) | | | |
| Concentrated | Blending | — | — | — |
| sulfuric acid | amount (g) | | | |

| | | | |
|---|---|---|---|
| First member to be | TEFLON | TEFLON | TEFLON |
| coated (material) | | | |
| Second member | — | Silica | Glass |
| to be coated | | particles | plate |
| Heating temperature (° C.) | 190 | 190 | 190 |
| Heating time (h) | 5 | 5 | 5 |
| Carbon coating on first | C | C | C |
| member to be coated | | | |
| Amount of carbon in second | — | — | — |
| member to be coated (EDX) | | | |
| Supernatant yield of | 0 | — | 0 |
| carbonaceous material | | | |
| Graphene production | Absent | Absent | Absent |

“TEFLON” described in the table is registered trademark.

TABLE 5

| | | Comparative | Comparative | Comparative | Comparative |
|---|---|---|---|---|---|
| | | Example 4 | Example 5 | Example 6 | Example 7 |
| Carboxylic | Type | Acetic | Acetic | Acetic | Ethanol |
| acid | | anhydride | anhydride | anhydride | |
| anhydride*¹ | Blending | 19.98 | 19.98 | 19.98 | 19.8 |
| | amount (g) | | | | |
| Concentrated | Blending | 0.02 | 0.02 | 0.02 | 0.2 |
| sulfuric acid | amount (g) | | | | |

| | | | | |
|---|---|---|---|---|
| First member to be | TEFLON | TEFLON | TEFLON | TEFLON |
| coated (material) | | | | |
| Second member | — | Silica | Glass | — |
| to be coated | | particles | plate | |
| Heating temperature (° C.) | 190 | 190 | 190 | 190 |
| Heating time (h) | 5 | 5 | 5 | 5 |
| Carbon coating on first | C | C | C | C |
| member to be coated | | | | |
| Amount of carbon in second | — | — | — | — |
| member to be coated (EDX) | | | | |
| Supernatant yield of | 0 | — | 0 | 0 |
| carbonaceous material | | | | |
| Graphene production | Absent | Absent | Absent | Absent |

“TEFLON” described in the table is registered trademark.
*¹Comparative Example 7 is a compound other than the carboxylic acid anhydride.

1. A method for producing a carbon-coated member, the method comprising:
a step of heating a coating composition including a carboxylic acid anhydride and sulfuric acid in a state in which a portion or the entirety of a surface of a member to be coated is in contact with the coating composition,
wherein a concentration of the sulfuric acid in the coating composition before heating is 0.4% by mass or more based on a sum of masses of the carboxylic acid anhydride and the sulfuric acid.

2. The method for producing a carbon-coated member according to claim 1, wherein a content of the carboxylic acid anhydride in the coating composition before heating is 40% by mass or more based on a total mass of the coating composition.

3. The method for producing a carbon-coated member according to claim 1, wherein a heating temperature in the step is 100° C. to 300° C.

4. The method for producing a carbon-coated member according to claim 1, wherein the member to be coated is in a particulate form.

5. The method for producing a carbon-coated member according to claim 1, wherein the member to be coated is an insulator.

6. A coating composition used for carbon-coating a surface of a member to be coated,
the coating composition comprising a carboxylic acid anhydride and sulfuric acid,
wherein a concentration of the sulfuric acid is 0.5% by mass or more based on a sum of masses of the carboxylic acid anhydride and the sulfuric acid.

7. The coating composition according to claim 6, wherein a content of the carboxylic acid anhydride is 40% by mass or more based on a total mass of the coating composition.

8. A method for producing a carbonaceous material, the method comprising:
a step of heating a carboxylic acid anhydride in the presence of a sulfuric acid within a system,
wherein an amount of the sulfuric acid present in the system before heating is 0.4% by mass or more based on a sum of masses of the carboxylic acid anhydride and the sulfuric acid.

9. The method for producing a carbonaceous material according to claim 8, wherein a heating temperature in the step is 100° C. to 300° C.
